(19) United States
(12) Patent Application Publication
(10) Pub. No.: US 2016/0294490 A1
(43) Pub. Date: Oct. 6, 2016

(54) CALIBRATION METHOD FOR WIRELESS COMMUNICATION DEVICE AND ASSOCIATED CALIBRATION APPARATUS

(71) Applicant: MEDIATEK INC., Hsin-Chu (TW)

(72) Inventors: Qiang Zhou, San Jose, CA (US); Ming-Chou Wu, Miaoli County (TW); Ting-Hsuan Kuo, Changhua County (TW); Chia-Sheng Peng, Taichung City (TW); Bernard Mark Tenbroek, West Malling (GB)

(21) Appl. No.: 15/015,134

(22) Filed: Feb. 4, 2016

Related U.S. Application Data
(60) Provisional application No. 62/141,264, filed on Apr. 1, 2015.

(51) Int. Cl. H04B 17/21

(52) U.S. Cl. CPC H04B 17/21

(57) ABSTRACT

A calibration method is applied to a wireless communication device having a programmable tuner and a signal processing path. The calibration method includes at least the following steps: configuring the programmable tuner to have a plurality of different tuner states, wherein the signal processing path has a first end and a second end, and the programmable tuner is coupled to the second end; when the programmable tuner is configured to have one of the different tuner states, obtaining a measured reflection coefficient at the first end of the signal processing path; and calibrating mapping relationship between a reflection coefficient at the first end of the signal processing path and a reflection coefficient at the second end of the signal processing path according to the different tuner states and measured reflection coefficients associated with the different tuner states.

### CROSS REFERENCE TO RELATED APPLICATIONS

This application claims the benefit of U.S. provisional application No. 62/141,264, filed on Apr. 1, 2015 and incorporated herein by reference.

### BACKGROUND

The disclosed embodiments of the present invention relate to a calibration mechanism, and more particularly, to a calibration method for a wireless communication device and an associated calibration apparatus.

Antennas can be used to transmit radio frequency (RF) signals over the air when wireless communication devices are operated in the transmit (TX) mode. However, an antenna used in a wireless communication device (e.g., a mobile phone) may lose efficiency due to certain factors. For example, the impedance mismatch between the antenna and the front-end module may result in antenna performance loss. When the antenna performance is degraded in the TX mode, a power amplifier is required to output an RF signal with a larger TX power to compensate the antenna loss. As a result, the current consumption of the power amplifier is increased. When the wireless communication device is a portable device powered by a battery, the battery life is short, which results in bad user experience of using the wireless communication device. If the mismatch is server, it might also cause the communication link to break. Hence, there is a need to perform antenna estimation to estimate the antenna gamma (i.e., reflection coefficient

$${Γ}_{L} = \frac{{Z}_{L} - {Z}_{0}}{{Z}_{L} + {Z}_{0}} ,$$

where Z_{L} is load impedance of an antenna, and Z₀ is characteristic impedance of a transmission line) that may be referenced for applying compensation to the wireless communication device.

### SUMMARY

In accordance with exemplary embodiments of the present invention, a calibration method for a wireless communication device and an associated calibration apparatus are proposed.

According to a first aspect of the present invention, an exemplary calibration method for a wireless communication device is disclosed. The exemplary wireless communication device includes a programmable tuner and a signal processing path. The calibration method includes: configuring the programmable tuner to have a plurality of different tuner states, wherein the signal processing path has a first end and a second end, and the programmable tuner is coupled to the second end; when the programmable tuner is configured to have one of the different tuner states, obtaining a measured reflection coefficient at the first end of the signal processing path; and calibrating mapping relationship between a reflection coefficient at the first end of the signal processing path and a reflection coefficient at the second end of the signal processing path according to the different tuner states and measured reflection coefficients associated with the different tuner states.

According to a second aspect of the present invention, an exemplary antenna estimation method is disclosed. The exemplary antenna estimation method includes: configuring a programmable tuner to have a first tuner state, wherein the programmable tuner is coupled between an antenna and a second end of a signal processing path; obtaining a first measured reflection coefficient at a first end of the signal processing path in response to the first tuner state; estimating a first reflection coefficient of the programmable tuner according to the first measured reflection coefficient and mapping relationship between a reflection coefficient at the first end of the signal processing path and a reflection coefficient at the second end of the signal processing path; and estimating a first reflection coefficient of the antenna according to the first reflection coefficient and the first tuner state of the programmable tuner.

According to a third aspect of the present invention, an exemplary multi-stage calibration method is disclosed. The exemplary multi-stage calibration method is applied to a signal processing path having a plurality of components, where the components include at least a first component, a second component and a third component. The exemplary multi - stage calibration method includes: disconnecting the second component from the first component, and calibrating mapping relationship between a reflection coefficient at a first end of the first component and a reflection coefficient at a second end of the first component; and connecting the second component to the first component and disconnecting the second component from the third component, and calibrating mapping relationship between a reflection coefficient at a first end of the second component and a reflection coefficient at a second end of the second component.

According to a fourth aspect of the present invention, an exemplary antenna estimation apparatus is disclosed. The exemplary antenna estimation apparatus includes a detection circuit and a controller. The detection circuit is arranged to generate a detection output by detecting a reflection coefficient at a first end of a signal processing path. The controller is arranged to generate a control output to a programmable tuner to configure the programmable tuner between an antenna and a second end of the signal processing path, and perform antenna estimation upon the antenna according to at least the control output and the detection output, wherein the detection circuit is located at a transceiver side and is distant from the antenna.

These and other objectives of the present invention will no doubt become obvious to those of ordinary skill in the art after reading the following detailed description of the preferred embodiment that is illustrated in the various FIGS. and drawings.

### BRIEF DESCRIPTION OF THE DRAWINGS

FIG. 1 is a diagram illustrating a calibration apparatus implemented in a wireless communication device according to an embodiment of the present invention.

FIG. 2 is a diagram illustrating a direct calibration scheme according to an embodiment of the present invention.

FIG. 3 is a diagram illustrating low variation property of tuner states according to an embodiment of the present invention.

FIG. 4 is a diagram illustrating wide spreading property of tuner states according to an embodiment of the present invention.

FIG. 5 is a flowchart illustrating a method of identifying a favorable tuner state set according to an embodiment of the present invention.

FIG. 6 is a flowchart illustrating a calibration method according to an embodiment of the present invention.

FIG. 7 is a diagram illustrating one measurement of a multi-stage calibration scheme according to an embodiment of the present invention.

FIG. 8 is a diagram illustrating another measurement of the multi-stage calibration scheme according to an embodiment of the present invention.

FIG. 9 is a flowchart illustrating an iterative antenna estimation method according to an embodiment of the present invention.

### DETAILED DESCRIPTION

Certain terms are used throughout the description and following claims to refer to particular elements. As one skilled in the art will appreciate, manufacturers may refer to a component by different names. This document does not intend to distinguish between elements that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

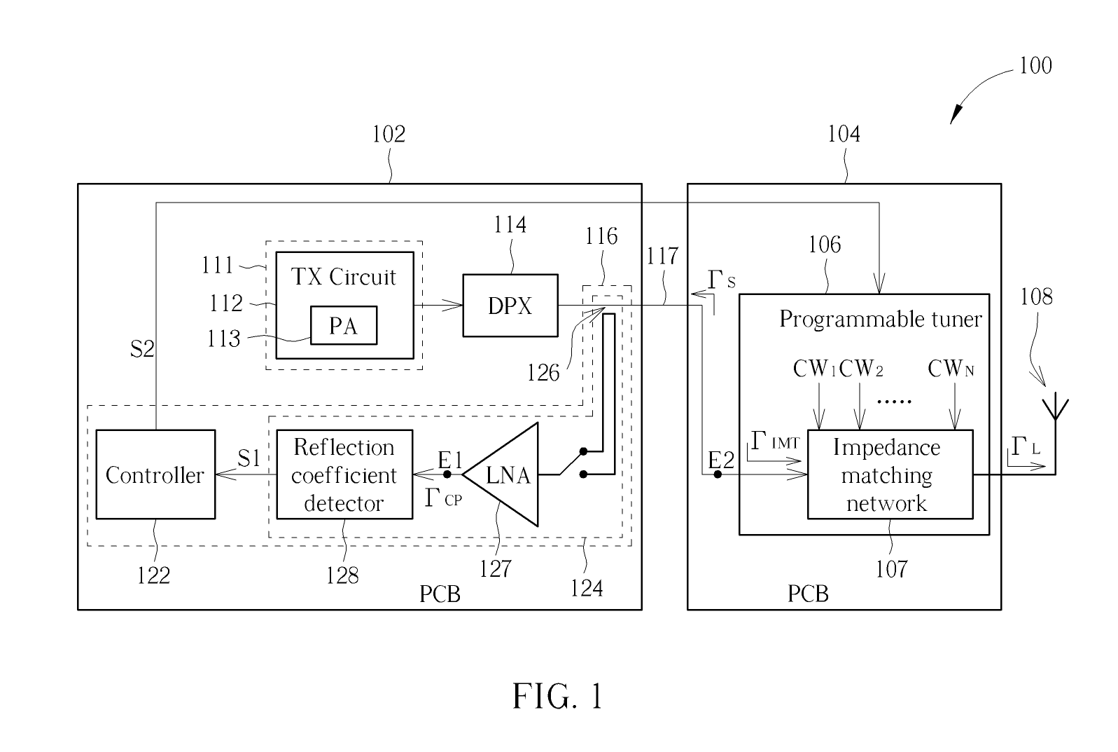

FIG. 1 is a diagram illustrating a calibration apparatus implemented in a wireless communication device according to an embodiment of the present invention. For example, the wireless communication device 100 may be a portable device such as a mobile phone. It should be noted that only the components pertinent to the present invention are shown in FIG. 1. In practice, the wireless communication device 100 may have additional components to achieve other functions. As shown in FIG. 1, the wireless communication device 100 includes two separate printed circuit boards (PCBs) 102 and 104. The PCB 104 has an antenna assembly installed thereon. In this embodiment, the antenna assembly includes a programmable tuner 106 and an antenna 108, where the programmable tuner 106 has an impedance matching network 107. The programmable tuner 106 supports a plurality of different tuner states corresponding to a plurality of different configurations of the impedance matching network 107, respectively. For example, the impedance matching network 107 has a plurality of tunable elements (e.g., tunable capacitors) controlled by a plurality of control words CW1, CW2, . . . , CWN, respectively; and each of the tunable elements (e.g., tunable capacitors) is controlled to have one of a plurality of different element values (e.g., different capacitance values) under the control of a corresponding control word. In addition, each of the tuner states supported by the programmable tuner 106 corresponds to one set of known S-parameters S₁₁, S₁₂, S₂₂, S₂₁. It should be noted that the number of tunable elements implemented in the impedance matching network 107 and the number of tuner states supported by the programmable tuner 106 may be adjusted, depending upon the actual design considerations.

The PCB 102 has a plurality of circuit elements installed thereon. For example, the circuit elements may include a transmit (TX) circuit 112 (which is part of a transceiver 111), a duplexer (DPX) 114, and a calibration apparatus 116. The TX circuit 112 includes circuit elements needed to generate a radio-frequency (RF) signal with a specific TX power to the programmable tuner 106. For example, the TX circuit 112 has a power amplifier (PA) 113, and a PA output of the TX circuit 112 is transmitted to the programmable tuner 106 through the duplexer 114 and a connection line 117. By way of example, but not limitation, the connection line 117 may be composed of PCB traces, connectors, and an RF coaxial cable. The duplexer 114 is a radio device that enables signal transmission and signal reception over a single antenna.

The calibration apparatus 116 may serve as an antenna estimation apparatus for estimating the antenna gamma (i.e., reflection coefficient

$${Γ}_{L} = \frac{{Z}_{L} - {Z}_{0}}{{Z}_{L} + {Z}_{0}} )$$

of the antenna 108. In this embodiment, the calibration apparatus 116 includes a controller 122 and a detection device 124, where the detection device 124 includes a coupler 126, a low-noise amplifier (LNA) 127, and a reflection coefficient detector 128. The reflection coefficient detector 128 is a detection circuit arranged to generate a detection output S1 by detecting a reflection coefficient at a first end E1 of a signal processing path, where a second end E2 of the signal processing path is coupled to the programmable tuner 106 (particularly, the impedance matching network 107). The controller 122 is used for antenna tuning and antenna estimation. For example, the controller 122 may be a microcontroller or a digital signal processor (DSP). In this embodiment, the controller 122 is arranged to perform antenna tuning by generating a control output S2 to the programmable tuner 106 for configuring the programmable tuner 106 between the second end E2 of the signal processing path and the antenna 108 , and is further arranged to perform antenna estimation upon the antenna 108 according to at least the control output S2 and the detection output S1. For example, the controller 122 may employ a direct calibration scheme to calibrate mapping relationship between a reflection coefficient Γ_{cp} at the first end E1 of the signal processing path and a reflection coefficient Γ_{IMT} at the second end E2 of the signal processing path, and then may employ an iterative antenna estimation scheme based on the mapping from Γ_{cp} to Γ_{IMT}. It should be noted that the antenna 108 is not disconnected from the programmable tuner 106 while the direct calibration scheme is being performed for calibrating the mapping from Γ_{cp} to Γ_{IMT}. Further details of proposed direct calibration scheme and proposed iterative antenna estimation scheme are described as below.

As shown in FIG. 1, the reflection coefficient detector 128 is located at a transceiver side and is distant from the antenna 108. There is a wide separation between the transceiver 111 and the antenna 108. The connection line 117 (which may be composed of PCB traces, connectors, and an RF coaxial cable) is needed to transmit signals between different PCBs 102 and 104. However, the cable impedance, the PCB trace impedance and the connector impedance are unknown factors. Further, the actual characteristic of the coupler 126 might deviate from its nominal values. Hence, calibration is essential for the case that the measurement is collected by a detection circuit (e.g., reflection coefficient detector 128) at the transceiver side. Specifically, these unknowns need to be calibrated for achieving an accurate estimation of the antenna 108 reflection. In one exemplary embodiment, a direct calibration scheme is employed to make the mapping from Γ_{cp} to Γ_{IMT} be accurate. The programmable tuner 106 with a selected tuner state has known S-parameters. Hence, with the help of the mapping from Γ_{cp} to Γ_{IMT} and the known S-parameters of the programmable tuner 106, the reflection coefficient Γ_{L} of the antenna 108 can be estimated accurately.

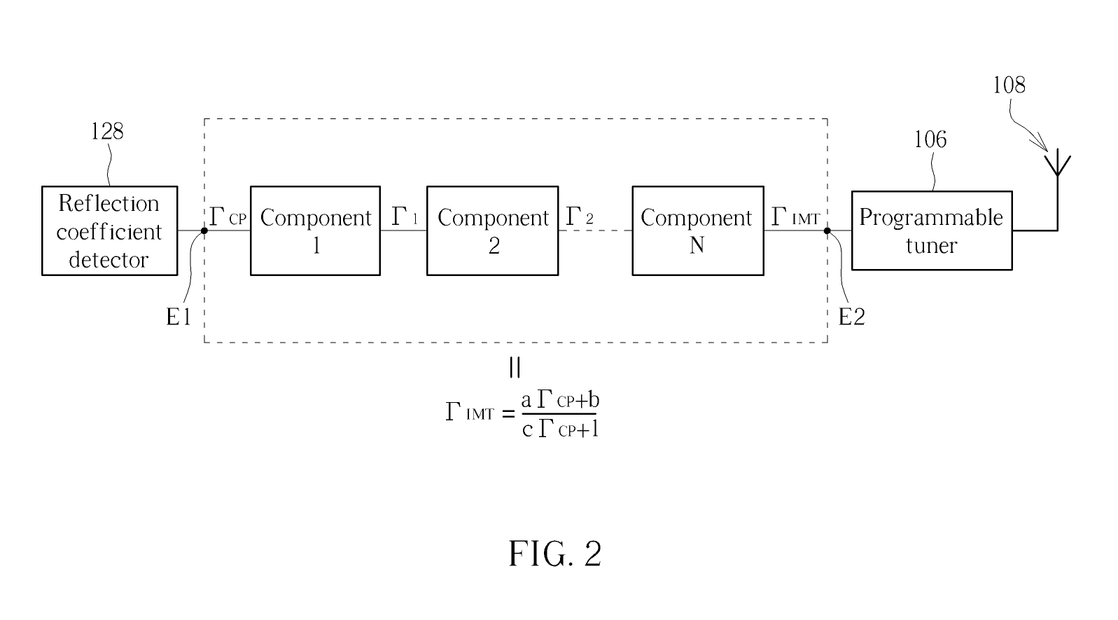

FIG. 2 is a diagram illustrating a direct calibration scheme according to an embodiment of the present invention. In a general setting, there may be N components cascaded between the reflection coefficient detector 128 and the programmable tuner 106. The direct calibration scheme lumps many variables into a simple model. For example, the components may include a coupler, PCB traces, connectors, RF coaxial cable, etc. By combining S-parameters of these cascaded components together, the mapping from Γ_{cp} to Γ_{IMT} (i.e., mapping relationship between a reflection coefficient Γ_{cp} at the first end E1 of the signal processing path and a reflection coefficient Γ_{IMT} at the second end E2 of the signal processing path) may be expressed using a common form

$${Γ}_{IMT} = \frac{a {Γ}_{CP} + b}{c {Γ}_{CP} + 1} ,$$

where each of the variables a, b, c is a combination of unknown component parameters. Since there are three unknown variables (a, b, c), at least three pairs of transceiver-side measurement Γ_{cp} and tuner input reflection Γ_{IMT} are required. For example, the unknown variables (a, b, c) may be determined by finding a least square (LS) solution of the following matrix.

$$[ \begin{matrix}{Γ}_{CP 1} & 1 & {Γ}_{CP 1} & {Γ}_{IMT 1} \\ {Γ}_{CP 2} & 1 & {Γ}_{CP 2} & {Γ}_{IMT 2} \\ … & & & \\ {Γ}_{CPn} & 1 & {Γ}_{CP n} & {Γ}_{IMT n}\end{matrix} ] [ \begin{matrix}a \\ b \\ c\end{matrix} ] = [ \begin{matrix}{Γ}_{IMT 1} \\ {Γ}_{IMT 2} \\ ⋯ \\ {Γ}_{IMT n}\end{matrix} ]$$

The programmable tuner 106 is a two-port device which can be described using S-parameters S₁₁, S₁₂, S₂₁, S₂₂. It should be noted that the S-parameters S₁₁, S₁₂, S₂₁, S₂₂ for any tuner state selected by the programmable tuner 106 are known parameters. The reflection coefficient Γ_{IMT} depends on the S-parameters S₁₁, S₁₂, S₂₂, S₂₁ of the programmable tuner 106 and the reflection coefficient Γ_{L} of the antenna 108. For example, the reflection coefficient Γ_{IMT} may be expressed as

$${Γ}_{IMT} = {S}_{11} + \frac{{S}_{12} {S}_{21} {Γ}_{L}}{1 - {S}_{22} {Γ}_{L}} .$$

As mentioned above, the impedance matching network 107 of the programmable tuner 106 has a plurality of tunable elements (e.g., tunable capacitors) controlled by a plurality of control words CW₁-CW_{N}, respectively; and each of the tunable elements (e.g., tunable capacitors) is controlled to have one of a plurality of different element values (e.g., different capacitance values) under the control of a corresponding control word. However, due to process variation, temperature variation and/or other factors, each of the element values (e.g., capacitance values) may be deviated from its nominal value. As a result, when the programmable tuner 106 is configured by the control words CW₁-CW_{N} to have a selected tuner state, a corresponding tuner input reflection coefficient Γ_{IMT} may be deviated from its nominal value. Further, as mentioned above, the reflection coefficient Γ_{IMT} may be expressed as

$${Γ}_{IMT} = {S}_{11} + \frac{{S}_{12} {S}_{21} {Γ}_{L}}{1 - {S}_{22} {Γ}_{L}} .$$

Hence, when the programmable tuner 106 is configured by the control words CW₁-CW_{N} to have a selected tuner state, a corresponding tuner input reflection coefficient Γ_{IMT} may be affected by the antenna loading. Moreover, nearby tuner states with similar S-parameters causing corresponding tuner input reflection coefficients Γ_{IMT} similar to each other may result in similar measurement results (i.e., similar measured reflection coefficients Γ_{cp}). This makes the LS matrix have a high condition number to be a singular matrix or close to a singular matrix, thus being numerically instable. Hence, a proper selection of tuner states is needed to obtain reliable estimation of the variables (a, b, c) that decide the mapping from Γ_{cp} to Γ_{IMT}.

In one exemplary embodiment, different favorable tuner states are selected by the controller 122 from candidate tuner states supported by the programmable tuner 106, and are used for calibrating the mapping relationship between a reflection coefficient Γ_{cp} at the first end E1 of the signal processing path and a reflection coefficient Γ_{IMT} at the second end E2 of the signal processing path. For example, each of the favorable tuner states satisfies three properties, including low variation, wide spreading and high isolation. Hence, each of the favorable tuner states has a reflection coefficient variation (i.e., variation of corresponding tuner input reflection coefficient Γ_{IMT}) from a nominal value smaller than a threshold value to thereby improve accuracy of the corresponding tuner input reflection coefficient decided by a known S-parameter setting of the favorable tuner state; any two of the favorable tuner states have reflection coefficient correlation therebetween smaller than a threshold value to thereby avoid high correlation that could cause a large condition number; and each of the favorable tuner states has a reflection coefficient impact from an antenna smaller than a threshold value to thereby improve accuracy of the corresponding tuner input reflection coefficient decided by a known S-parameter setting of the favorable tuner state.

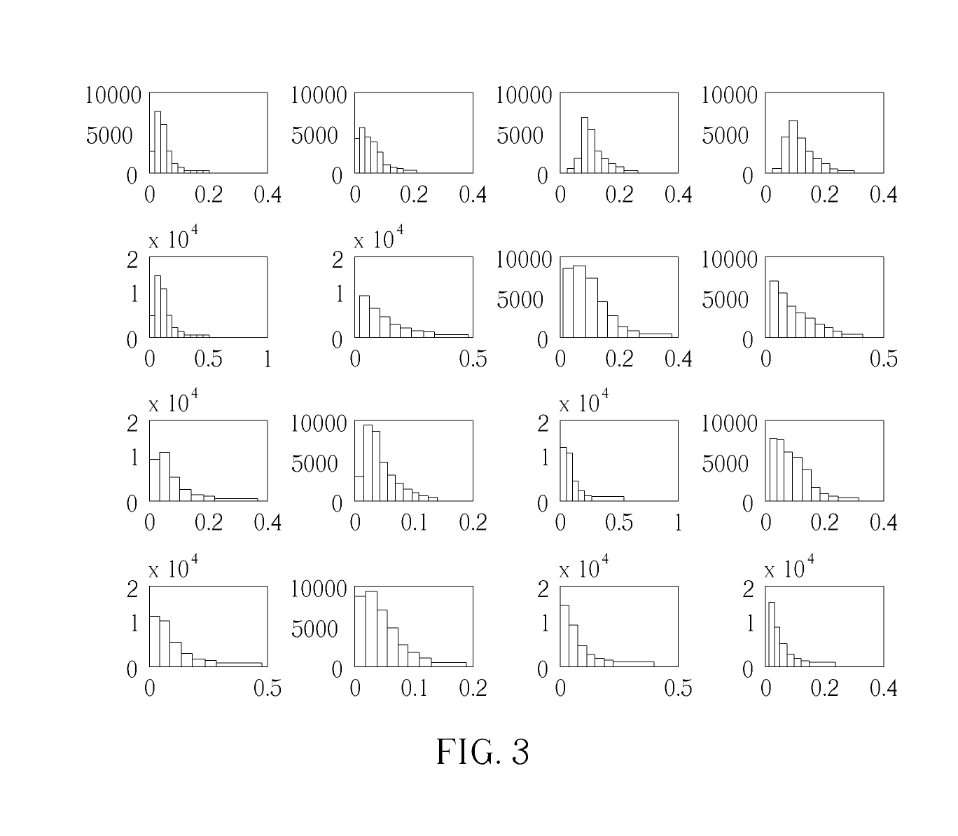

FIG. 3 is a diagram illustrating low variation property of tuner states according to an embodiment of the present invention. In a practical programmable tuner, the variations from nominal states are not uniform. In this example, it is assumed that the impedance matching network 107 has 16 tunable elements (e.g., tunable capacitors) each controlled to have one of a plurality of different element values (e.g., different capacitance values). Regarding each of the tunable elements, a histogram of variation is illustrated in FIG. 3. There are certain tuner states having small variation. Typically, the number of low variation tuner states is limited.

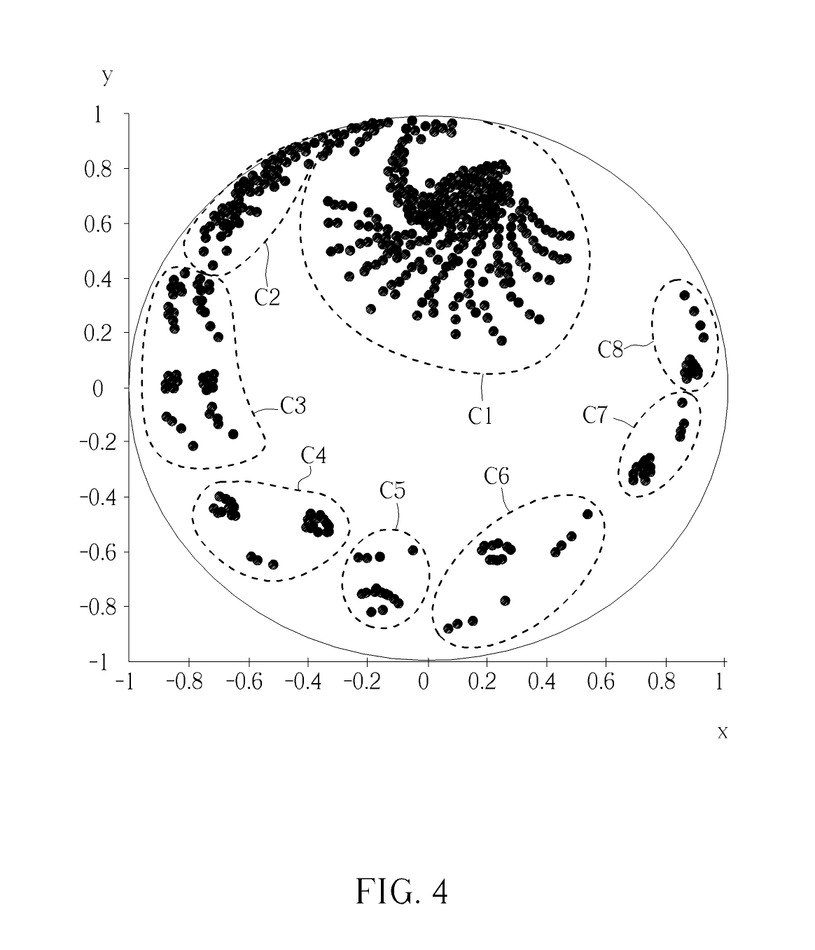

FIG. 4 is a diagram illustrating wide spreading property of tuner states according to an embodiment of the present invention. The tuner states may form a plurality of clusters (groups) C1-C8 as indicated in the plot. Choosing nearby tuner states from the same cluster (group) may potentially cause the LS matrix to result in a high condition number. To meet the wide spreading requirement, distant tuner states from the same cluster (group) or tuner states from different clusters (groups) maybe chosen. Inpractice, many selection strategies may be available for choosing wide spreading tuner states. In a first exemplary design, a random sampling scheme can be employed to choose tuner states. In a second exemplary design, a hierarchical clustering scheme can be employed to choose a representative tuner state from each cluster. In a third exemplary design, a heuristic selection scheme can be employed to choose tuner states based on detail tuner knowledge. However, these are for illustrative purposes only, and are not meant to be limitations of the present invention.

As mentioned above, the reflection coefficient Γ_{IMT} may be expressed as

$${Γ}_{IMT} = {S}_{11} + \frac{{S}_{12} {S}_{21} {Γ}_{L}}{1 - {S}_{22} {Γ}_{L}} ,$$

where the impact from the antenna

$$\frac{{S}_{12} {S}_{21} {Γ}_{L}}{1 - {S}_{22} {Γ}_{L}}$$

may be regarded as an error term E(Γ_{L}). To meet the high isolation requirement, any tuner state that makes

$$\frac{\vert {S}_{11} \vert}{\vert E ( {Γ}_{L} ) \vert}$$

larger than a threshold value can be chosen.

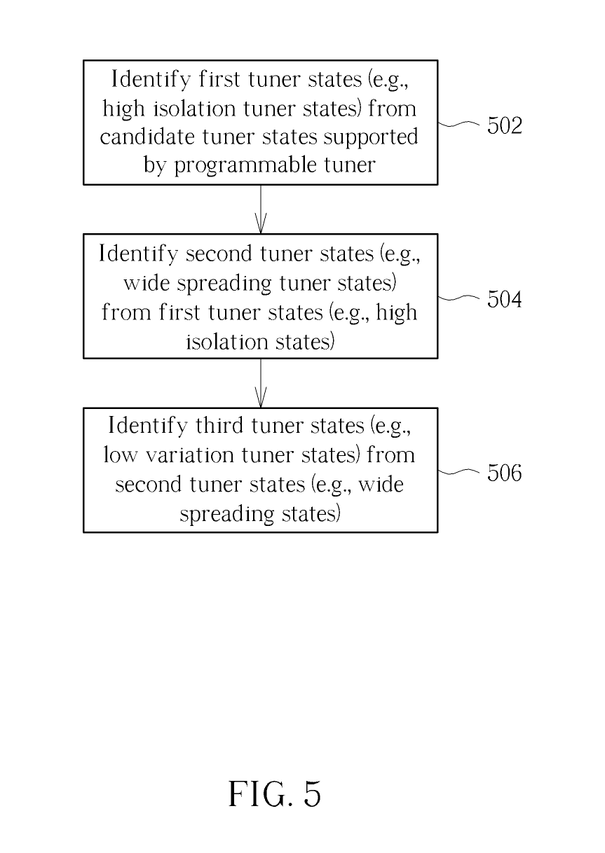

FIG. 5 is a flowchart illustrating a method of identifying a favorable tuner state set according to an embodiment of the present invention. Provided that the result is substantially the same, the steps are not required to be executed in the exact order shown in FIG. 5. In addition, certain steps may be added to or removed from the flow shown in FIG. 5. The method may be performed by the controller 122 and may be briefly summarized as below.

Step 502: Check candidate tuner states supported by the programmable tuner 106 to identify first tuner states from the candidate tuner states, wherein each of the first tuner states has a reflection coefficient impact from an antenna smaller than a first threshold value. For example, high isolation tuner states are identified from candidate tuner states supported by the programmable tuner 106.

Step 504: Check the first tuner states to identify second tuner states from the first tuner states, wherein the second tuner states include tuner states with reflection coefficient correlation therebetween smaller than a second threshold value. For example, wide spreading tuner states are chosen from high isolation tuner states obtained in step 502.

Step 506: Check the second tuner states to identify third tuner states from the second tuner states, wherein each of the third tuner states has a reflection coefficient variation from a nominal value smaller than a third threshold value. For example, low variation tuner states are chosen from the wide spreading tuner states obtained in step 504.

The favorable tuner states used for calibrating the mapping from Γ_{cp} to Γ_{IMT} can be derived from the third tuner states obtained in step 506. It should be noted that the order of identifying high isolation tuner states, identifying wide spreading tuner states and identifying low variation tuner states may be adjusted, depending upon actual design considerations. These alternative designs all fall within the scope of the present invention.

As mentioned above, the number of low variation tuner states is limited. That is, there may be relatively large number of wide spreading and high isolation tuner states, but a limited number of low variation tuner states. Those low variation tuner states may come from some special considerations in the antenna tuner design. Hence, it is possible that the number of favorable tuner states included in the favorable tuner state set is not large enough to determine the variables (a, b, c) by solving an LS equation defined by pairs of transceiver-side measurement Γ_{cp} and tuner input reflection Γ_{IMT}, where one measured reflection coefficient Γ_{cp} is obtained for each favorable tuner state set to the programmable tuner 106 by the control output S2 generated from the controller 122. The present invention therefore proposes determining the variables (a, b, c) by using favorable tuner states as well as sub-favorable tuner states.

In another exemplary embodiment, different favorable tuner states and different sub-favorable tuner states are selected by the controller 122 from candidate tuner states supported by the programmable tuner 106, and are used for calibrating the mapping relationship between a reflection coefficient Γ_{cp} at the first end E1 of the signal processing path and a reflection coefficient Γ_{IMT} at the second end E2 of the signal processing path. For example, each of the favorable tuner states satisfies three properties including low variation, wide spreading and high isolation; and each of the sub-favorable tuner states satisfies only two properties including wide spreading and high isolation. The sub-favorable tuner states used for calibrating the mapping from Γ_{cp} to Γ_{IMT} can be derived from the second tuner states obtained in step 504.

The number of sub-favorable tuner states included in the sub-favorable tuner state set is large enough to determine the variables (a′, b′, c) by solving an LS equation defined by pairs of transceiver-side measurement Γ_{cp} and tuner input reflection Γ_{IMT}, where one measured reflection coefficient Γ_{cp} is obtained for each sub-favorable tuner state set to the programmable tuner 106 by the control output S2 generated from the controller 122. Since sub-favorable tuner states are used to solve the LS equation, the variables a′ and b′ are deviated from the actual variables a and b of the mapping from Γ_{cp} to Γ_{IMT}. However, the variable c obtained by solving the LS equation according to the sub-favorable tuner states and measured reflection coefficients corresponding to the sub-favorable tuner states is substantially equal to the actual variable c of the mapping from Γ_{cp} to Γ_{IMT}. After the variable c is obtained by solving the LS equation according to the sub-favorable tuner states and measured reflection coefficients corresponding to the sub-favorable tuner states, the actual variables a and b of the mapping from Γ_{cp} to Γ_{IMT} can be determined based on the favorable tuner states and measured reflection coefficients corresponding to the favorable tuner states.

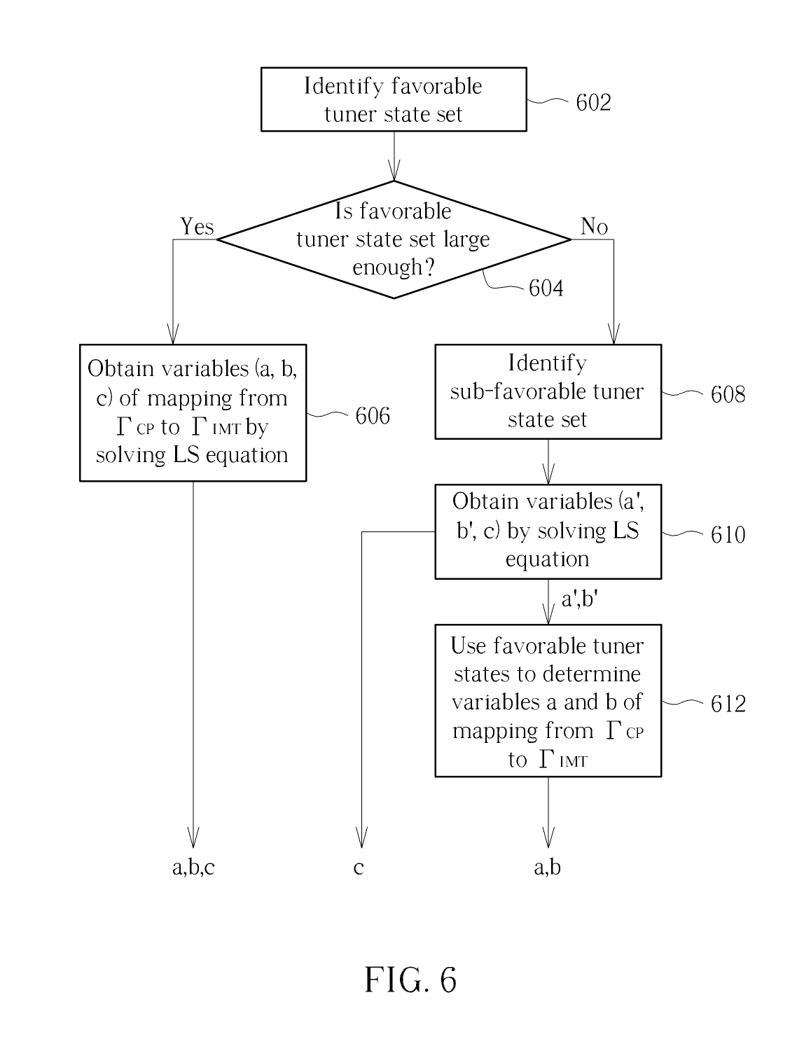

FIG. 6 is a flowchart illustrating a calibration method according to an embodiment of the present invention. Provided that the result is substantially the same, the steps are not required to be executed in the exact order shown in FIG. 6. In addition, certain steps may be added to or removed from the flow shown in FIG. 6. The calibration method may be performed by the controller 122 according to the detection output S1 generated to the programmable tuner 106 and the control output S2 generated from the reflection coefficient detector 128, and may be briefly summarized as below.

Step 602: Identify a favorable tuner state set. For example, the favorable tuner state set is composed of high isolation, wide spreading and low variation tuner states chosen from candidate tuner states supported by the programmable tuner 106.

Step 604: Check if the favorable tuner state set is large enough. If yes, go to step 606; otherwise, go to step 608.

Step 606: Obtain actual variables (a, b, c) of the mapping from Γ_{cp} to Γ_{IMT} by solving an LS equation defined by the favorable tuner

states (which decide the tuner input reflection coefficients Γ_{IMT1}−Γ_{IMTn}) and the corresponding measured reflection coefficients Γ_{CP1}−Γ_{CPn}.

Step 608: Identify a sub-favorable tuner state set. For example, the sub-favorable tuner state set is composed of high isolation and wide spreading tuner states chosen from candidate tuner states supported by the programmable tuner 106.

Step 610: Obtain variables (a′, b′, c) by solving an LS equation defined by the sub-favorable tuner states (which decide the tuner input reflection coefficients Γ_{IMT1}−Γ_{IMTn}) and the corresponding measured reflection coefficients Γ_{CP1}−Γ_{CPn}. The actual variable c of the mapping from Γ_{cp} to Γ_{IMT} can be obtained in step 610.

Step 612: Determine actual variables a and b of the mapping from Γ_{cp} to Γ_{IMT} according to the favorable tuner states and measured reflection coefficients corresponding to the favorable tuner states.

The calibration method can be performed in a flexible manner, depending upon availability of sufficient favorable states. In addition, the direct calibration scheme is easy to implement and could be a factory calibration or an on-the-fly calibration. As a person skilled in the art can readily understand details of each step shown in FIG. 6 after reading above paragraphs, further description is omitted here for brevity.

As shown in FIG. 1, the programmable tuner 106 is coupled to a source (e.g., PA 113) via the connection line 117. As the connection line 117 has cable and connector combined together, it is not a transmission line. Therefore, the source impedance is not zero. The reflection coefficient Γ_{S} may be expressed as

$${Γ}_{S} = {S}_{22} + \frac{{S}_{12} {S}_{21} {Γ}_{PA}}{1 - {S}_{22} {Γ}_{PA}} .$$

However, there is no way to get an accurate estimation of the source impedance because PA impedance is not reflected in the transceiver-side measurement obtained at the reflection coefficient detector 128. However, assuming that there is good directivity and calibration is performed with at least two low variation tuner states, an S-parameter S22 used for source impedance matching may be roughly estimated according to a ratio of the variable c to the variable a. That is,

$${S}_{22} = \frac{c}{a} .$$

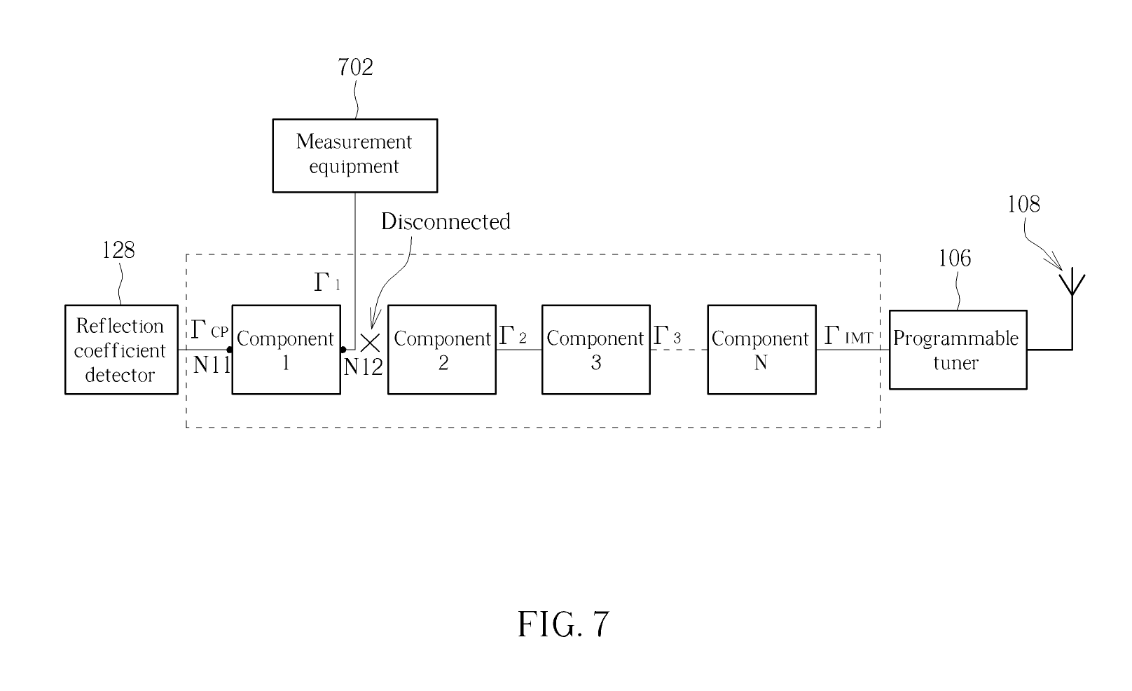

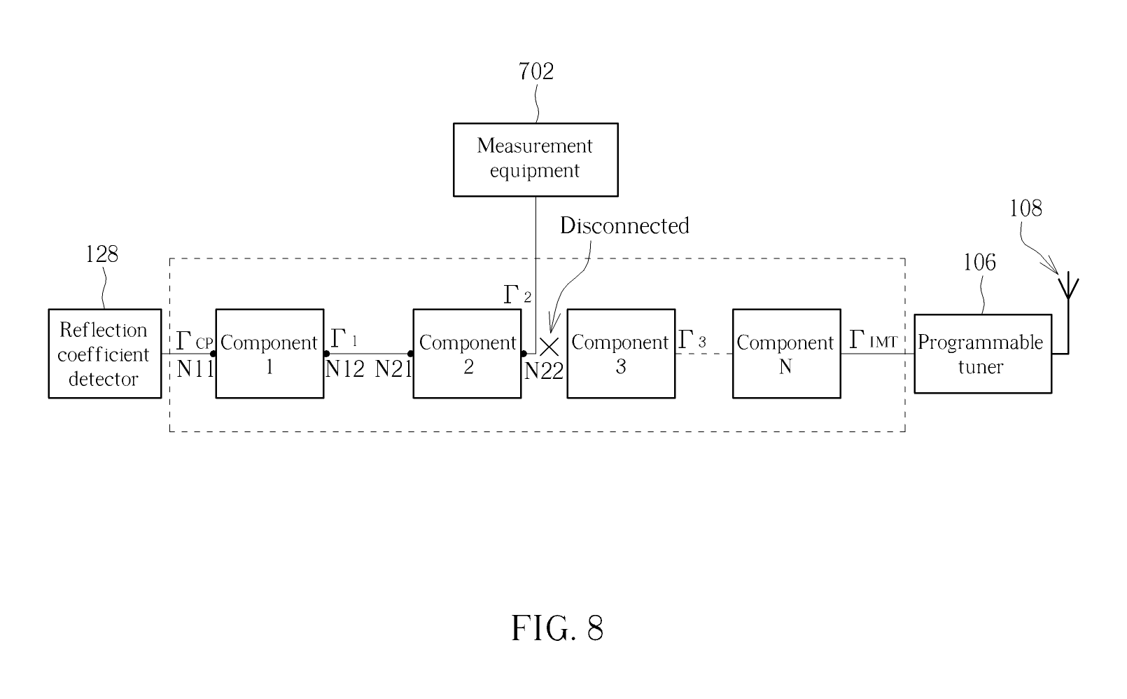

In above exemplary implementation shown in FIG. 2, a direct calibration scheme can be employed to calibrate mapping relationship between a reflection coefficient Γ_{cp} at the first end E1 of the signal processing path and a reflection coefficient Γ_{IMT} at the second end E2 of the signal processing path. Alternatively, a multi-stage calibration scheme may be employed, where the calibration can be carried out in a sequential multi-stage fashion, e.g., from Γ_{cp} to Γ₁, from Γ₁ to Γ₂, and so forth. FIG. 7 and FIG. 8 are diagrams illustrating a multi-stage calibration scheme according to an embodiment of the present invention. The multi-stage calibration is applied to a signal processing path having a plurality of components (denoted by “component 1”, “component 2”, “component 3”, . . . , “component N”). The reflection coefficient detector 128 is connected to the component 1, and the programmable tuner 106 is connected to the component N. As shown in FIG. 7, the component 2 is intentionally disconnected from the second end N12 of the component 1, and the measurement equipment 702 is connected to the second end N12 of the component 1 via a probe. The reflection coefficient detector 128 connected to the first end N11 of the component 1 is able to obtain a measured reflection coefficient Γ_{CP}, and the measurement equipment 702 connected to the second end N12 of the component 1 is able to obtain a measured reflection coefficient Γ₁. In this way, the mapping from Γ_{CP} to Γ₁ can be determined, and the single-stage calibration procedure of component 1 is done.

It should be noted that, to maintain equivalence to the direct calibration scheme, the input to an intermediate stage needs to be obtained from the output from its previous stage. As shown in FIG. 8, the first end N21 of the component 2 is connected to the second end N12 of the component 1, and the second end N22 of the component 2 is intentionally disconnected from the component 3. In addition, the measurement equipment 702 is connected to the second end N22 of the component 2 via a probe. The reflection coefficient detector 128 connected to the first end N11 of the component 1 is able to obtain a measured reflection coefficient Γ_{CP}, and the measurement equipment 702 connected to the second end N22 of the component 2 is able to obtain a measured reflection coefficient Γ₂. In this way, the mapping from Γ_{CP} to Γ₂ can be determined. Since the mapping from Γ_{CP} to Γ₁ is already determined in the previous calibration stage, the mapping from Γ₁ to Γ₂ can be determined according to the mapping from Γ_{CP} to Γ₁ and the mapping from Γ_{CP} to Γ₂. The single-stage calibration procedure of component 2 is done.

As a person skilled in the art can readily understand details of the proposed multi-stage calibration employed for calibrating each of the subsequent components (i.e. , component 3 to component N) after reading above paragraphs, further description is omitted here for brevity.

The reasons for such a multi-stage calibration arrangement could be to check each individual component's physical property. For example, component 1 may be the coupler 126. Hence, checking the mapping from Γ_{CP} to Γ₁ can be used to verify how good the coupler 126 is implemented. It should be noted that the calibration error carried over to the next stage will be corrected in the next stage.

After the mapping from Γ_{CP} to Γ_{IMT} is determined by either the direct calibration scheme or the multi-stage calibration scheme, the antenna estimation can be performed to estimate the reflection coefficient Γ_{L} of the antenna 108. As mentioned above, the reflection coefficients Γ_{IMT} and Γ_{L} have the following relationship:

$${Γ}_{IMT} = {S}_{11} + \frac{{S}_{12} {S}_{21} {Γ}_{L}}{1 - {S}_{22} {Γ}_{L}} .$$

When the programmable tuner 106 is configured to have a specific tuner state, the S-parameters S₁₁, S₁₂, S₂₁, S₂₂ of the programmable tuner 106 are known. The measured reflection coefficient Γ_{CP} can be obtained by the reflection coefficient detector 128 when the programmable tuner 106 is configured to have the specific tuner state. After the measured reflection coefficient Γ_{CP} is obtained, the reflection coefficient Γ_{IMT} can be determined according to the mapping from Γ_{CP} to Γ_{IMT} that is determined by either the direct calibration scheme or the multi-stage calibration scheme. Since the S-parameters S₁₁, S₁₂, S₂₁, S₂₂ of the programmable tuner 106 are known, and the reflection coefficient Γ_{IMT} is obtained from the procedure described above, the reflection coefficient Γ_{L} of the antenna 108 can be estimated using the equation

$${Γ}_{IMT} = {S}_{11} + \frac{{S}_{12} {S}_{21} {Γ}_{L}}{1 - {S}_{22} {Γ}_{L}} .$$

However, calibration error will be carried over to antenna estimation error. It is observed that the larger the RTG, the smaller the antenna estimation error. Hence, the mapping from the calibration error to the antenna estimation error can be compressed by a large RTG. However, without an accurate antenna estimation, it is difficult to set the programmable tuner 106 to achieve a large RTG in a single step. The present invention therefore proposes an iterative antenna estimation scheme to set the programmable tuner 106 to achieve a large RTG by performing antenna estimation and the antenna tuning iteratively. The proposed iterative antenna estimation scheme can improve antenna estimation accuracy without additional hardware cost.

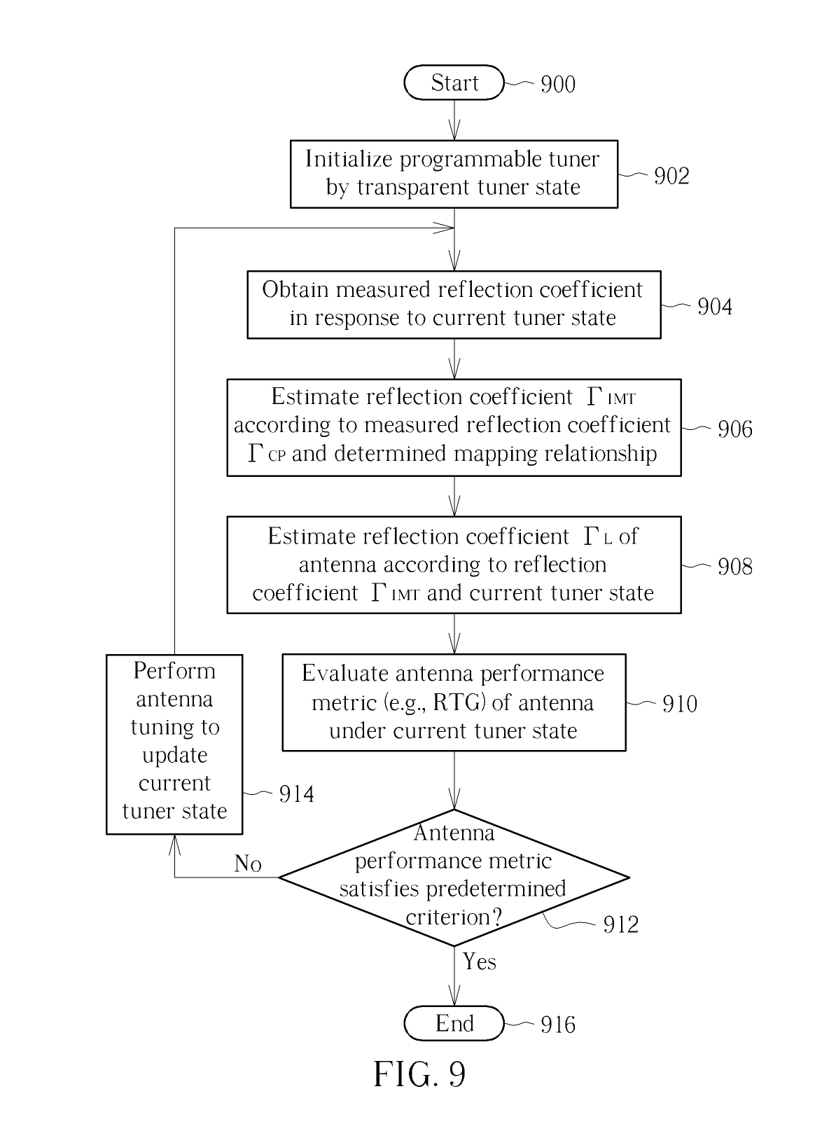

FIG. 9 is a flowchart illustrating an iterative antenna estimation method according to an embodiment of the present invention. Provided that the result is substantially the same, the steps are not required to be executed in the exact order shown in FIG. 9. In addition, certain steps may be added to or removed from the flow shown in FIG. 9. The iterative antenna estimation method may be performed by the controller 122 according to the control output S2 (which sets the tuner state of the programmable tuner 106) , the mapping from Γ_{CP} to Γ_{IMT} (which is determined by either the direct calibration scheme or the multi-stage calibration scheme), and the detection output S2 (which provides the measured reflection coefficient Γ_{CP}). The iterative antenna estimation method may be briefly summarized as below.

Step 900: Start.

Step 902: Initialize the programmable tuner 106 by a current tuner state being a transparent tuner state.

Step 904: Obtain a measured reflection coefficient Γ_{CP} at the first end E1 of the signal processing path in response to the current tuner state.

Step 906: Estimate a reflection coefficient Γ_{IMT} of the programmable tuner 106 according to the measured reflection coefficient Γ_{CP} and the mapping from Γ_{CP} to Γ_{IMT} (i.e., mapping relationship between a reflection coefficient at the first end E1 of the signal processing path and a reflection coefficient at the second end E2 of the signal processing path).

Step 908: Estimate a reflection coefficient Γ_{L} of the antenna 108 according to the reflection coefficient Γ_{IMT} and the current tuner state of the programmable tuner 106.

Step 910 : Evaluate an antenna performance metric of the antenna 108 under the current tuner state of the programmable tuner 106. For example, the antenna performance metric may be a relative transducer gain (RTG).

Step 912: Check if the antenna performance metric satisfies a predetermined criterion. If yes, go to step 916; otherwise, go to step 914.

Step 914: Perform antenna tuning to update the current tuner state to a different tuner state. For example, the update searches for a new tuner state that will result in a better RTG than the current tuner state. Go to step 904.

Step 916: End.

At the beginning of the iterative antenna estimation flow, the programmable tuner 106 is initialized by a transparent tuner state (Step 902). For example, among all candidate tuner states supported by the programmable tuner 106, the transparent tuner state makes the programmable tuner 106 have a maximum of S₁₂ times S₂₁. The use of the transparent tuner state achieves largest possible RTG without the knowledge of antenna 108 reflection. Steps 904-908 are executed to perform the antenna estimation under the current tuner state. After the reflection coefficient Γ_{L} of the antenna 108 is estimated, the antenna performance metric (e.g., RTG) can be estimated (Step 910). The RTG is defined as

$$\frac{incident power to antenna w \text{/} tuner}{incident power to antenna w \text{/} o tuner} .$$

For example, assuming that there is perfect source impedance matching

$$( i . e . , {Γ}_{S} = \frac{{Z}_{S} - {Z}_{0}}{{Z}_{S} + {Z}_{0}} = 0 ) ,$$

the RTG may be estimated according to the reflection coefficient Γ_{L}of the antenna 108 and S-parameters of the programmable tuner 106 configured by the current tuner state. In step 912, the estimated antenna performance metric (e.g., RTG) is checked to determine if a predetermined criterion (e.g., a stop condition of the iterative antenna estimation flow) is satisfied. For example, the predetermined criterion (e.g., stop condition of the iterative antenna estimation flow) is satisfied when the RTG is converged to a maximum RTG value. When the predetermined criterion (e.g., stop condition of the iterative antenna estimation flow) is satisfied, the reflection coefficient Γ_{L} obtained in step 908 is used as an antenna estimation result of the antenna 108. However, when the predetermined criterion (e.g., stop condition of the iterative antenna estimation flow) is not satisfied yet, the current tuner state is updated (Step 914), e.g., searching for a tuner state that improves RTG, and the next iteration of antenna estimation is performed (Steps 904-908). In summary, the antenna estimation and the antenna tuning are performed iteratively until the estimated RTG is converged to the maximum RTG value.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration method for a wireless communication device, the wireless communication device comprising a programmable tuner and a signal processing path, the calibration method comprising:
configuring the programmable tuner to have a plurality of different tuner states, wherein the signal processing path has a first end and a second end, and the programmable tuner is coupled to the second end;
when the programmable tuner is configured to have one of the different tuner states, obtaining a measured reflection coefficient at the first end of the signal processing path; and
calibrating mapping relationship between a reflection coefficient at the first end of the signal processing path and a reflection coefficient at the second end of the signal processing path according to the different tuner states and measured reflection coefficients associated with the different tuner states.

2. The calibration method of claim 1, wherein the signal processing path includes a plurality of cascaded components.

3. The calibration method of claim 1, wherein the different tuner states include at least one tuner state each having a reflection coefficient variation from a nominal value smaller than a threshold value.

4. The calibration method of claim 1, wherein the different tuner states include tuner states with reflection coefficient correlation therebetween smaller than a threshold value.

5. The calibration method of claim 1, wherein the different tuner states include at least one tuner state each having a reflection coefficient impact from an antenna smaller than a threshold value.

6. The calibration method of claim 1, further comprising:
checking candidate tuner states supported by the programmable tuner to identify first tuner states from the candidate tuner states;
checking the first tuner states to identify second tuner states from the first tuner states;
checking the second tuner states to identify third tuner states from the second tuner states; and
determining the different tuner states according to at least the third tuner states;
wherein each of the third tuner states has a reflection coefficient impact from an antenna smaller than a first threshold value, the third tuner states include tuner states with reflection coefficient correlation therebetween smaller than a second threshold value, and each of the third tuner states has a reflection coefficient variation from a nominal value smaller than a third threshold value.

7. The calibration method of claim 6, wherein determining the different tuner states comprises:
checking if a number of the third tuner states satisfies a predetermined criterion; and
when the number of the third tuner states satisfies the predetermined criterion, determining the different tuner states solely based on the third tuner states.

8. The calibration method of claim 6, wherein determining the different tuner states comprises:
checking if a number of the third tuner states satisfies a predetermined criterion;
when the number of the third tuner states does not satisfy the predetermined criterion, identifying fourth tuner states from the second tuner states, and determining the different tuner states based on the third tuner states and the fourth tuner states, wherein each of the fourth tuner states has a reflection coefficient impact from an antenna smaller than the first threshold value, and the fourth tuner states include tuner states with reflection coefficient correlation therebetween smaller than the second threshold value.

9. The calibration method of claim 8, wherein calibrating the mapping relationship comprises:
determining a first variable of the mapping relationship according to the fourth tuner states and measured reflection coefficients corresponding to the fourth tuner states; and
after the first variable is determined, determining a second variable and a third variable of the mapping relationship according to the third tuner states and measured reflection coefficients corresponding to the third tuner states.

10. The calibration method of claim 9, further comprising:
estimating an S-parameter S22 used for source impedance matching according to a ratio of the first variable to the second variable.

11. The calibration method of claim 1, wherein an antenna is not disconnected from the programmable tuner while the calibration method is being performed.

12. The calibration method of claim 1, wherein the wireless communication device further comprises a detection circuit and a plurality of separate circuit boards including a first circuit board and a second circuit board, the programmable tuner is located at the first circuit board, the detection circuit is located at the second circuit board and coupled to the first end of the signal processing path for obtaining the measured reflection coefficients corresponding to the different tuner states.

13. An antenna estimation method comprising:
configuring a programmable tuner to have a first tuner state, wherein the programmable tuner is coupled between an antenna and a second end of a signal processing path;
obtaining a first measured reflection coefficient at a first end of the signal processing path in response to the first tuner state;
estimating a first reflection coefficient of the programmable tuner according to the first measured reflection coefficient and mapping relationship between a reflection coefficient at the first end of the signal processing path and a reflection coefficient at the second end of the signal processing path; and
estimating a first reflection coefficient of the antenna according to the first reflection coefficient and the first tuner state of the programmable tuner.

14. The antenna estimation method of claim 13, further comprising:
when the programmable tuner is configured to have the first tuner state, evaluating an antenna performance metric of the antenna; and
checking if the antenna performance metric satisfies a predetermined criterion.

15. The antenna estimation method of claim 14, further comprising:
when the predetermined criterion is satisfied, using the first reflection coefficient as an antenna estimation result of the antenna.

16. The antenna estimation method of claim 14, further comprising:
when the predetermined criterion is not satisfied:
obtaining a second measured reflection coefficient at the first end of the signal processing path in response to the second tuner state;
estimating a second reflection coefficient of the programmable tuner according to the second measured reflection coefficient and the mapping relationship; and
estimating a second reflection coefficient of the antenna according to the second reflection coefficient and the second tuner state of the programmable tuner.

17. The antenna estimation method of claim 14, wherein the antenna performance metric is a relative transducer gain (RTG).

18. The antenna estimation method of claim 13, wherein the programmable tuner is initialized by the first tuner state being a transparent tuner state.

19. A multi-stage calibration method applied to a signal processing path having a plurality of components, the components comprising at least a first component, a second component and a third component, the multi-stage calibration method comprising:
disconnecting the second component from the first component, and calibrating mapping relationship between a reflection coefficient at a first end of the first component and a reflection coefficient at a second end of the first component; and
connecting the second component to the first component and disconnecting the second component from the third component, and calibrating mapping relationship between a reflection coefficient at a first end of the second component and a reflection coefficient at a second end of the second component.

20. An antenna estimation apparatus comprising:
a detection circuit, arranged to generate a detection output by detecting a reflection coefficient at a first end of a signal processing path; and
a controller, arranged to generate a control output to a programmable tuner to configure the programmable tuner coupled between an antenna and a second end of the signal processing path, and perform antenna estimation upon the antenna according to at least the control output and the detection output;
wherein the detection circuit is located at a transceiver side and is distant from the antenna.
